(19) United States
(12) Patent Application Publication
(10) Pub. No.: US 2025/0281920 A1
(43) Pub. Date: Sep. 11, 2025

(54) METHODS FOR REDUCING SMALL PORES OF CATALYST CARRIERS

(71) Applicant: Scientific Design Company, Inc., Little Ferry, NJ (US)

(72) Inventors: Mure Te, Little Ferry, NJ (US); Li Zhu, Little Ferry, NJ (US); Yunxia Chen, Little Ferry, NJ (US); Xiankuan Zhang, Houston, TX (US); Lixin Cao, Little Ferry, NJ (US); Jorge Ron, East Brunswick, NJ (US)

(73) Assignee: Scientific Design Company, Inc., Little Ferry, NJ (US)

(21) Appl. No.: 19/072,491

(22) Filed: Mar. 6, 2025

Related U.S. Application Data
(60) Provisional application No. 63/562,963, filed on Mar. 8, 2024.

(51) Int. Cl. B01J 37/00; B01J 23/50

(52) U.S. Cl. CPC B01J 37/0009; B01J 23/50

(57) ABSTRACT

Methods are provided in which small pores having a size of less than 0.3 microns are substantially reduced by utilizing a caustic solution. In some embodiments, the reduction of the small sized pores of less than 0.3 microns is achieved by treating a preformed catalyst carrier with a hot caustic solution. In other embodiments, the reduction of small sized pores of less than 0.3 microns is achieved by adding a caustic solution to a carrier composition during the preparation/formation of a catalyst carrier. The caustic solution treated catalyst carrier exhibits a positive/upward shift of the small pore size distribution.

### CROSS REFERENCE TO RELATED APPLICATION

The present invention claims the benefit of U.S. Provisional Patent Application No. 63/562,963 filed Mar. 8, 2024, the entire content and disclosure of which is incorporated herein by reference.

### BACKGROUND

The present disclosure relates to a catalyst carrier (or catalyst support), and more particularly to methods of reducing small pores (i.e., pore size of less than 0.3 microns) of a catalyst carrier.

Catalysts which are used in the commercial scale production of ethylene oxide (EO) by the catalytic vapor phase oxidation of ethylene with molecular oxygen are generally required to possess high activity, high selectivity and high durability (i.e., long catalyst lifetime). Various studies have been made in regard to improving the activity and/or the selectivity and/or the durability of EO catalysts. In this connection, efforts have been made to improve reaction promoters of EO catalysts and/or carriers of EO catalysts.

The carrier for EO catalysts is typically an alpha alumina carrier. Existing alpha alumina carriers for EO catalysts still leave much to be clarified and improved. For example, physical properties of the alpha alumina carrier such as specific surface area, pore diameter, pore distribution, pore volume and porosity and chemical properties of such carrier materials await improvements for the sake of optimization.

In EO catalysis, small pore size distributions of the carrier that are below 0.3 microns are generally undesirable since such small size pore can negatively impact EO catalyst performance, especially for EO selectively. In the prior art, the small size pore distribution of the carrier is largely dictated by the available alumina raw materials (i.e., alumina source) that is used in forming the carrier, and such small size pore distribution cannot be easily controlled. There is thus a need for providing methods for reducing the pore volume percentage that have a pore size of less than 0.3 microns in EO catalyst carriers.

### SUMMARY

Methods are provided in which the pore volume percentage of small pores having a size of less than 0.3 microns is substantially reduced by utilizing a caustic solution. In some embodiments, the reduction of the small sized pores of less than 0.3 microns is achieved by treating a preformed catalyst carrier with a hot caustic solution. In other embodiments, the reduction of small sized pores of less than 0.3 microns is achieved by adding a caustic solution to a carrier composition (i.e., carrier formulation) during the preparation/formation of a catalyst carrier. The caustic solution treated catalyst carrier exhibits a positive/upward shift of the small pore size distribution.

In one aspect of the present disclosure, a method of reducing the small pore size distribution of a catalyst carrier is provided. In one embodiment, the method includes contacting a preformed catalyst carrier having a pore size distribution of less than 0.3 microns with a caustic solution to provide an admixture of the caustic solution and the preformed catalyst carrier. Next, the admixture is heated to a temperature of about 70° C. or greater to provide a caustic solution treated preformed catalyst carrier. The caustic solution treated preformed catalyst carrier is then cooled to nominal room temperature and thereafter dried. The dried caustic solution treated preformed catalyst carrier is then calcined at a temperature of about 1200° C. or greater, and after calcining, the calcined caustic solution treated preformed catalyst carrier is washed to provide a catalyst carrier having a reduced pore volume percentage of pores having a pore size of less than 0.3 microns as compared to the preformed catalyst carrier.

In another aspect of the present disclosure, a method of forming a catalyst carrier is provided. In one embodiment, the method includes adding a caustic solution to a carrier composition (i.e., formulation) to provide an admixture of the carrier composition and caustic solution. Next, the admixture is formed into a shaped body and thereafter the shaped body is calcined at a temperature of about 1200° C. greater to convert the shaped body into a catalyst carrier. The catalyst carrier that is formed using the caustic solution has a reduced pore volume percentage of pores having a size of less than 0.3 microns as compared to an equivalent catalyst carrier that is made without the caustic solution.

### BRIEF DESCRIPTION OF THE DRAWINGS

FIG. 1 is a graph illustrating the pore size distribution of catalyst carrier 1 prior to NaOH treatment, and catalyst carrier 1 after NaOH treatment.

FIG. 2 is a graph illustrating the pore size distribution of catalyst carrier 2 prior to NaOH treatment, and catalyst carrier 2 after NaOH treatment.

FIG. 3 is a graph illustrating the pore size distribution of catalyst carrier 3 prior to NaOH treatment, and catalyst carrier 3 after NaOH treatment.

FIGS. 4A-4B are scanning electron micrographs (SEMs) showing the morphology of catalyst carrier 1 prior to NaOH treatment and after NaOH treatment, respectively.

FIGS. 5A-5B are SEMs showing the morphology of catalyst carrier 2 prior to NaOH treatment and after NaOH treatment, respectively.

FIGS. 6A-6B are SEMs showing the morphology of catalyst carrier 3 prior to NaOH treatment and after NaOH treatment, respectively.

FIG. 7 is a graph illustrating the pore size distribution of catalyst carrier 4 made without NaOH, catalyst carrier 4A made with 0.3 wt. % NaOH, catalyst carrier 4B made with 0.6 wt. % NaOH, catalyst carrier 4C made with 1.2 wt. % NaOH.

FIGS. 8A-8D are SEMs showing the morphology of catalyst carrier 4 made without NaOH, catalyst carrier 4A made with 0.3 wt. % NaOH, catalyst carrier 4B made with 0.6 wt. % NaOH, catalyst carrier 4C made with 1.2 wt. % NaOH, respectively.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups

Methods are provided in which the pore volume percentage of small pores having a size of less than 0.3 microns is substantially reduced by utilizing a caustic solution. In some embodiments, the reduction of the small sized pores of less than 0.3 microns is achieved by treating a preformed catalyst carrier with a hot caustic solution. In other embodiments, the reduction of small sized pores of less than 0.3 microns is achieved by adding a caustic solution to a carrier composition (i.e., catalyst formulation) during the preparation/formation of a catalyst carrier. In the present disclosure, the caustic solution treated catalyst carrier exhibits a positive/upward shift of the small pore size distribution. These aspects of the present disclosure will now be described in greater detail.

Preformed Catalyst Carrier Treatment with a Caustic Solution

In some embodiments, the reduction of small sized pores of less than 0.3 microns is obtained by treating a preformed catalyst carrier having a pore size distribution of less than 0.3 microns with a hot caustic solution. In this embedment, the hot caustic treated preformed catalysts carrier exhibits a positive/upward shift of the small pore size distribution from a value of less than 0.3 microns. By “preformed catalyst carrier” it is meant a catalyst carrier that has been previously made/shaped/calcined utilizing any known catalyst carrier preparation/formation process. The catalyst carrier preparation/formation process can include providing a carrier composition (i.e., formulation) including at least one alumina source (i.e., an alumina powder), shaping the carrier composition into a shaped body and calcining the shaped body. The alumina source is typically an alpha alumina powder.

The preformed catalyst carrier typically includes at least about 85 wt. %, more typically at least about 90 wt. %, and even more typically at least about 95 wt. %, alpha-alumina. The remaining components of the preformed catalyst carrier can include inorganic oxides other than alpha-alumina, such as silica, alkali metal oxides (e.g., sodium oxide) and trace amounts of other metal-containing or non-metal-containing additives or impurities.

The preformed catalyst carrier that can be employed in the present disclosure typically has a pore volume from about 0.3 mL/g to about 1.2 mL/g. The pore volume reported in the present disclosure can be measured by Mercury Porosimetry in accordance with ASTM D4284. More typically, the preformed catalyst carrier that can be employed in the present disclosure has a pore volume from about 0.35 mL/g to about 0.9 mL/g. In some embodiments, the preformed catalyst carrier that can be employed in the present disclosure has a water absorption from about 30 percent to about 90 percent, with a range from about 35 percent to about 70 percent being more typical. The water absorption reported in the present disclosure can be measured by method similar to ASTM C373-18. The preformed catalyst carrier that can be employed in the present disclosure typically has a surface area from about 0.1 m²/g to about 5.0 m²/g, with a surface area from about 0.3 m²/g to about 4.5 m²/gm being more typical. The surface area reported in the present disclosure can be measured in accordance with ASTM D3663-20.

The preformed catalyst carrier that can be employed in the present disclosure is typically multimodal pore size distributions, such as, for example, bimodal. The preformed catalyst carrier includes a least one pore mode having a pore size distribution of less than 0.3 microns. The at least one pore mode having a pore size distribution of less than 0.3 microns can constitute at least about 50% or less of the total pore volume of the preformed catalyst carrier. More typically, the at least one pore mode having a pore size distribution of less than 0.3 microns can constitute from about 10% to about 40% of the total pore volume of the preformed catalyst carrier. Even more typically, the at least one pore mode having a pore size distribution of less than 0.3 microns can constitute from about 20% to about 30% of the total pore volume of the preformed catalyst carrier. In some embodiments, the preformed catalyst carrier contains at least about 90 percent of the pore volume of the preformed catalyst is attributed to pores having a pore size of about 20 microns or less. In yet another embodiment of the present disclosure, at least about 85 percent of the pore volume of the preformed catalyst carrier is attributed to pores having a size from about 1 micron to about 6 microns. In yet a further embodiment of the present disclosure, less than about 15, preferably less than about 10, percent of the pore volume of preformed catalyst carrier is attributed to pores having a size of less than about 1 micron. In still a further embodiment of the present disclosure, at least about 80 percent of the pore volume of the preformed catalyst carrier is attributed to pores having a size from about 1 micron to 10 microns.

In one embodiment, the preformed catalyst carrier that can be employed in the present disclosure can be bimodal having a first set of pores from about 0.01 microns to about 1 micron and a second set of pores from greater than about 1 micron to about 10 microns. In such an embodiment, the first set of pores may constitute less than about 15 percent of the total pore volume of the preformed catalyst carrier of the present disclosure, while the second set of pores may constitute more than 85 percent of the total pore volume of the porous body. In yet another embodiment, the first set of pores may constitute less than about 10 percent of the total pore volume of the preformed catalyst carrier of the present disclosure, while the second set of pores may constitute more than about 90 percent of the total pore volume of the preformed catalyst carrier of the present disclosure.

The preformed catalyst carrier that can be employed in the present disclosure typically has an average flat plate crush strength from about 10 N to about 150 N, wherein N is Newtons. More typically, the preformed catalyst carrier that can be employed in the present disclosure has an average flat plate crush strength from about 40 N to about 105 N. The crush strength reported herein is an average flat crush strength that can be measured in accordance with ASTM 4179-22.

In some embodiments, the preformed catalyst carrier that can be employed in the present disclosure has an initial low alkali metal content. By “low alkali metal content” it is meant that the preformed catalyst carrier contains from about 2000 ppm or less, typically from about 30 ppm to about 300 ppm of alkali metal therein. Preformed catalyst carriers containing low alkali metal content can be obtained by adding substantially no alkali metal during the carrier manufacturing process. By “substantially no alkali metal” it is meant that only trace amounts of alkali metal are used during the performed carrier manufacture process as impurities from other constituents of the preformed catalyst carrier that can be employed in the present disclosure. In another embodiment, a preformed catalyst having a low alkali metal content can be obtained by performing various washing steps. The washing steps can include washing in a base, an acid, water, or another solvent.

The preformed catalyst carrier that can be employed in the present disclosure can be made utilizing conventional carrier manufacturing processes that are well known to those skilled in the art. Without being limited to the specific compositions and formulations contained therein, further information on carrier compositions and methods for making catalyst carriers can be found, for example, in U.S. Patent Publication No. 2007/0037991.

After providing a preformed catalyst carrier, the preformed catalyst carrier is subjected to hot caustic solution treatment. The treating of the preformed catalyst carrier with hot caustic solution includes contacting the preformed catalyst carrier with a caustic solution to provide a caustic solution treated preformed catalyst carrier. In the present disclosure, the caustic solution that can be used in the contacting step includes a base having a pH value of about 10 or greater that is present in a solution. Illustrative examples of such bases that can be used as a component of the caustic solution include, but are not limited to, LiOH, NaOH, KOH, or CsOH. The solution is typically, but not necessarily always, water. In embodiments, the caustic solution that is used for treating the preformed catalyst carrier has a molarity of from about 0.1 M to about 2 M, with a molarity from about 0.3 M to about 1 M being more typically. In the present disclosure, the molarity represents the molar concentration which is a measure of the concentration of a chemical species of a solute (here, for example, the base) in a solution (e.g., water), in terms of moles of substance per liter of solution.

In the present disclosure, the contacting includes adding the caustic solution to the preformed catalyst carrier to provide an admixture of the caustic solution and the preformed catalyst carrier. The amount of caustic solution that is added to the preformed catalyst carrier is typically from about 2 ml to about 10 ml per gram of preformed catalyst carrier. More typically, the amount of caustic solution that is added to the preformed catalyst carrier is from about 3 ml to about 5 ml per gram of preformed catalyst carrier. The contacting can be conducted in the presence of stirring. The stirring can be continuous or intermediate stirring can be used after adding a quantity of the caustic solution to the preformed catalyst carrier.

After providing the admixture of the caustic solution and the preformed catalyst carrier, the admixture is heated to a temperature from about 70° C. or greater, with a contact temperature from about 80° C. to about 90° C. being more typical. The duration of the heating step can vary. In one example, the heating step is conducted over a time period from about 1 to about 5 hours. The heating step can be conducted in the presence of stirring. The stirring can be continuous or intermediate stirring can be used. The heating provides a caustic solution treated preformed catalyst carrier.

The caustic solution treated preformed catalyst carrier is then cooled to nominal room temperature, and thereafter the cooled caustic solution treated preformed catalyst carrier can be decanted and dried. In the present disclosure, the term “nominal room temperature” denotes a temperature from about 18° C. to about 25° C. Cooling can be performed in air or under a vacuum. Drying, which also can be performed in air or under a vacuum, can include any drying means, such as, for example, air drying, oven drying or drying under a heat lamp. The drying step removes the water from the caustic solution treated preformed catalyst carrier.

The dried caustic solution treated preformed catalyst carrier is then subjected to a calcinating step. The calcination step can be performed at a temperature of about 1200° C. or greater, with a calcination temperature from about 1250° C. to about 1550° C. being more typical. The calcinating step employed can be performed in air, an inert ambient of any combination thereof. In one example, the calcinating step can be in flowing air. After the calcinating step, the resultant calcined caustic solution treated preformed catalyst carrier is cooled to nominal room temperature. The heating and cooling rates can be within a range from 1° C./min up to 5° C./min. Other heating and cooling rates within a range from 0.5° C./min up to 20° C./min can also be used in the present disclosure.

After calcining, the calcined caustic solution treated preformed catalyst carrier is washed to provide a catalyst carrier having a reduced residual caustic impurity and reduced pore volume percentage of pores having a pore size of less than 0.3 microns as compared to the preformed catalyst carrier prior to the treatment with the caustic solution. In the present disclosure, the washing step includes washing in deionized water. The wash can be a single wash or multiple washing can be employed.

The catalyst carrier that is provided after the above treatment of a preformed catalyst carrier with a hot caustic solution has a reduced pore size distribution as compared to the preformed catalyst carrier prior to the treatment with the caustic solution. Notably, the catalyst carrier that is provided after the above treatment of a preformed catalyst carrier with a caustic solution has a reduced pore volume percentage of small pores having a size of less than 0.3 microns as compared to the preformed catalyst carrier prior to the treatment with the caustic solution. A reduction of from about greater than 3% to about less than 1.2% in small sized pores volumes can be obtained utilizing the hot caustic solution treatment process mentioned above. In embodiments of the present application, the small size pore distribution of less than 0.3 microns shifts upwards. In some embodiments, the upward shift is from small size pore distribution of less than 0.3 microns to a larger pore size distribution of greater than 0.6 microns. In some embodiments, the upward shift is from small size pore distributions of less than 0.3 microns to a larger pore size distribution of greater than 0.6 microns.

In embodiments of the present disclosure, the caustic solution treated preformed catalyst carrier can also exhibit a decrease in surface area, water absorption, and pore volume as compared to the equivalent untreated preformed catalyst carrier. Also, and in embodiments, of the present disclosure, the caustic solution treated preformed catalyst carrier can also exhibit an increase in average flat plate crush strength as compared to the untreated preformed catalysts carrier.

### II: Catalyst Carrier Preparation Including a Caustic Solution

In some embodiments, the reduction of small sized pores of less than 0.3 microns is obtained by adding a caustic solution to a carrier composition during the preparation/formation of a catalyst carrier. In such embodiments, the carrier composition includes any conventional carrier composition in which at least one alumina source (i.e., alumina powder) is used in forming a catalyst carrier. In some embodiments, the carrier composition includes at least one alpha alumina powder, a non-silicate binder, a primary burnout material, solvents, and lubricants. An example of a non-silicate binder is bochmite (γ-AlOOH). Typically, the non-silicate binder is dispersed into deionized water or another solvent. In the present disclosure, the alpha alumina powder that is used in the catalyst composition can be a milled alpha alumina powder, an unmilled alpha alumina powder and a combination of milled and unmilled alpha alumina powders. In some embodiments, the alpha alumina powder is milled alpha alumina powder having a particle size from about 0.1 microns to about 6 microns.

When unmilled alpha alumina powder is employed. The unmilled alpha alumina powder that can be used in the present disclosure can have an average particle size in a range from about 10 microns to about 100 microns. When unmilled alpha alumina powder is employed with milled alpha alumina powder, the weight ratio of milled alpha alumina powder to unmilled alpha alumina powder can be from about 1:10 to about 10:1.

The primary burnout material that can be used includes any conventional burnout material having a particle size from about 1 micron to about 10 microns. Some examples of primary burnout materials that can be used as the burnout material include cellulose, substituted celluloses, e.g., methylcellulose, ethylcellulose, and carboxyethylcellulose, stearates (e.g., organic stearate esters, such as methyl or ethyl stearate), waxes, granulated polyolefins (e.g., polyethylene and polypropylene), walnut shell flour, and the like, which are burned out at the firing temperatures used in preparation of the catalyst carrier. An auxiliary burnout material can be optionally employed. When employed, the auxiliary burnout material has a particle size that is greater than the particle size of the primary burnout material mentioned above. The auxiliary burnout material may be a same, or different, burnout material as the primary burnout material. In one example, graphite having a particle size from about 3 microns to about 10 microns can be used as the auxiliary burnout material. In another example, paraffin or PTFE having a particle size from about 1 micron to about 9 microns can be used as the auxiliary burnout material. When an auxiliary burnout material is used, the weight ratio of the primary burnout material to the auxiliary burnout material can be in a range from about 1 to 5.

As mentioned above, a lubricant can be contained within the catalyst carrier composition. When present, the lubricant can include a conventional lubricant such as, for example, Petrolatum Jelly, can be used. The amount of lubricant that can be added at this point of the present invention may comprise the total amount of, or a partial amount, of the lubricant that used in forming the catalyst carrier of the present application.

The remaining components of the composition that can be employed can include inorganic oxides other than alpha-alumina, such as silica, alkali metal oxides (e.g., sodium oxide) and trace amounts of other metal-containing or non-metal-containing additives or impurities. Without being limited to the specific compositions and formulations contained therein, further information on carrier compositions and methods for making catalyst carriers can be found, for example, in U.S. Patent Publication No. 2007/0037991.

Notwithstanding the type of carrier composition that is employed, a caustic solution is added to the carrier composition. In this embodiment, the caustic solution that can be added to the carrier composition the same caustic solution that is mentioned in the previous embodiment in which a preformed catalyst carrier is treated with a hot caustic solution. In the present disclosure, the caustic solution is added to the carrier composition in an amount from about 0.5 wt. % to about 2.5 wt. % based on the total wight of alumina source that is present in the carrier composition. More typically, the amount of caustic solution that is added to the carrier composition is from about 1 wt. % to about 1.5 wt. % based on the total wight of alumina source that is present in the carrier composition. The addition can occur in the presence of continuous or intermediate stirring.

The caustic solution added carrier composition (i.e., admixture), is then formed into a shaped body. The shape that is formed by the forming step may vary and can be selected based upon the desired application of the resultant catalyst carrier that is eventually formed. Forming of the admixture is typically performed by pressing, extrusion, molding, casting, etc. In one embodiment of the present disclosure, extruding may be performed using an extruder die that can produce hollow cylinder shapes which then can be cut to pieces of substantially equal length. The extrudate after cutting is then dried using any conventional drying means.

After forming the shaped body, the shaped body is subjected to a calcinating step. The calcination step can be performed at a temperature of about 1200° C. or greater, with a calcination temperature from about 1250° C. to about 1550° C. being more typical. The calcinating step employed can be performed in air, an inert ambient of any combination thereof. In one example, the calcinating step can be in flowing air. After the calcinating step, the resultant catalyst carrier is cooled to nominal room temperature. The heating and cooling rates can be within a range from 1° C./min up to 5° C./min. Other heating and cooling rates within a range from 0.5° C./min up to 20° C./min can also be used in the present disclosure.

After calcining, the catalyst carrier can be washed to provide a catalyst carrier having a reduced pore volume percentage of pores having a pore size of less than 0.3 microns as compared to an equivalent catalyst carrier prepared without caustic solution addition. In the present disclosure, the washing step includes washing in deionized water. The wash can be a single wash or multiple washing can be employed.

The catalyst carrier that is formed with caustic solution addition typically includes at least about 85 wt. %, more typically at least about 90 wt. %, and even more preferably at least about 95 wt. %, alpha-alumina. The remaining components of the catalyst carrier that is formed with caustic solution addition can include inorganic oxides other than alpha-alumina, such as silica, alkali metal oxides (e.g., sodium oxide) and trace amounts of other metal-containing or non-metal-containing additives or impurities.

The catalyst carrier that is formed with caustic solution addition typically has a pore volume from about 0.2 mL/g to about 0.8 mL/g, with a pore volume from about 0.3 mL/g to about 0.5 mL/g being more typical. In some embodiments, the catalyst carrier that is formed with caustic solution addition has a water absorption from about 20 percent to about 80 percent, with a range from about 30 percent to about 50 percent being more typical. The catalyst carrier that is formed with caustic solution addition typically has a surface area from about 0.3 m²/g to about 3.0 m²/g, with a surface area from about 0.5 m²/g to about 1.2 m²/g being more typical.

The catalyst carrier that is formed with caustic solution addition is typically multimodal pore size distributions such as, for example, bimodal. The catalyst carrier that is formed with caustic solution addition can include at least one pore mode having a pore size distributions of less than 0.3 microns. The at least one pore mode having a pore size distributions of less than 0.3 microns can constitute at least about 60% or less of the total pore volume of the preformed catalyst carrier. More typically, the at least one pore mode having a pore size distributions of less than 0.3 microns can constitute from about 1% to about 40% of the total pore volume of the preformed catalyst carrier. Even more typically, the at least one pore mode having a pore size distributions of less than 0.3 microns can constitute from about 10% to about 30% of the total pore volume of the preformed catalyst carrier. In some embodiments, the catalyst carrier that is formed with caustic solution addition contains at least about 90 percent of the pore volume of the porous body is attributed to pores having a pore size of about 20 microns or less. In yet another embodiment of the present disclosure, at least about 85 percent of the pore volume of the preformed catalyst carrier is attributed to pores having a size from about 1 micron to about 6 microns. In yet a further embodiment of the present disclosure, less than about 15, preferably less than about 10, percent of the pore volume of preformed catalyst carrier is attributed to pores having a size of less than about 1 micron. In still a further embodiment of the present disclosure, at least about 80 percent of the pore volume of the preformed catalyst carrier is attributed to pores having a size from about 1 micron to 10 microns.

In some embodiments, a catalyst carrier that is formed with caustic solution addition has an initial low alkali metal content. Catalyst carriers that are formed with caustic solution addition containing low alkali metal content can be obtained by adding substantially no alkali metal during the carrier manufacturing process. In another embodiment, a catalyst carrier that is formed with caustic solution addition having a low alkali metal content can be obtained by performing various washing steps. The washing steps can include washing in a base, an acid, water, or another solvent.

In one embodiment of the present disclosure, catalyst carrier that is formed with caustic solution addition can have a silica content, as measured as SiO₂, of less than about 0.5, preferably less than about 0.3, weight percent, and a sodium content, as measured as Na₂O, of less than about 0.2 weight percent, preferably less than about 0.1, weight percent. In some embodiments, the catalyst carrier that is formed with caustic solution addition can have an acid leachable sodium content of 40 ppm or less.

### III. Catalyst Including Catalyst Carriers Having Small Porre Size Reduction

In another embodiment, the catalyst carriers described above can contain one or more catalytically active species, typically metals, disposed on or in the carrier. That is, the catalyst carrier formed by treating a preformed catalyst carrier with a hot caustic solution or the catalyst carrier made from the intentional caustic solution addition during the carrier manufacturing process can contain one or more catalytically active species. The one or more catalytically active materials can catalyze a specific reaction and are well known in the art. In some embodiments, the catalytically active material includes one or more transition metals from Groups 3-14 of the Periodic Table of Elements and/or lanthanides. In such applications, one or more promoting species (i.e., species that aide in a specific reaction) can be also disposed on or in the catalyst carrier of the present disclosure. The one or more promoting species may be, for example, alkali metals, alkaline earth metals, transition metals, and/or an element from Groups 15-17 of the Periodic Table of Elements.

In an embodiment in which the catalyst carrier of the present disclosure (either the catalyst carrier formed by treating a preformed catalyst carrier with a hot caustic solution or the catalyst carrier made from the intentional caustic solution addition during the carrier manufacturing process) is employed as a carrier for silver-based epoxidation catalysis, the catalyst carrier of the present disclosure includes silver on and/or in the carrier. Silver can be incorporated on or into the catalyst carrier by means well known in the art, e.g., by impregnation of a silver salt followed by thermal treatment, as well known in the art, as described in, for example, U.S. Pat. Nos. 4,761,394, 4,766,105, 4,908,343, 5,057,481, 5,187,140, 5,102,848, 5,011,807, 5,099,041 and 5,407,888, all of which are incorporated herein by reference. The concentration of silver salt in the solution is typically in the range from about 0.1% by weight to the maximum permitted by the solubility of the particular silver salt in the solubilizing agent employed. More typically, the concentration of silver salt is from about 0.5% by weight of silver to 45% by weight of silver, and even more typically, from about 5% by weight of silver to 35% by weight of silver by weight of the catalyst carrier. The foregoing amounts are typically also the amounts by weight found in the catalyst after thermal treatment. To be suitable as an ethylene epoxidation catalyst, the amount of silver should be a catalytically effective amount for ethylene epoxidation, which can be any of the amounts provided above.

In addition to silver, the silver-based epoxidation catalyst of the present disclosure can also include any one or more promoting species in a promoting amount. The one or more promoting species can be incorporated into the catalyst carrier of the present disclosure either prior to, coincidentally with, or subsequent to the deposition of the silver. As used herein, a “promoting amount” of a certain component of a catalyst refers to an amount of that component that works effectively to provide an improvement in one or more of the catalytic properties of the catalyst when compared to a catalyst not containing said component.

For example, the silver-based epoxidation catalyst can include a promoting amount of a Group I alkali metal or a mixture of two or more Group 1 alkali metals. Suitable Group 1 alkali metal promoters include, for example, lithium, sodium, potassium, rubidium, cesium or combinations thereof. Cesium is often preferred, with combinations of cesium with other alkali metals also being preferred. The amount of alkali metal will typically range from about 10 ppm to about 3000 ppm, more typically from about 15 ppm to about 2000 ppm, more typically from about 20 ppm to about 1500 ppm, and even more typically from about 50 ppm to about 1000 ppm by weight of the total catalyst, expressed in terms of the alkali metal.

The silver-based epoxidation catalyst can also include a promoting amount of a Group 2 alkaline earth metal or a mixture of two or more Group 2 alkaline earth metals. Suitable alkaline earth metal promoters include, for example, beryllium, magnesium, calcium, strontium, and barium or combinations thereof. The amounts of alkaline earth metal promoters are used in similar amounts as the alkali metal promoters described above.

The silver-based epoxidation catalyst can also include a promoting amount of a main group element or a mixture of two or more main group elements. Suitable main group elements include any of the elements in Groups 13 (boron group) to 17 (halogen group) of the Periodic Table of the Elements. In one example, a promoting amount of one or more sulfur compounds, one or more phosphorus compounds, one or more boron compounds or combinations thereof can be used.

The silver-based epoxidation catalyst can also include a promoting amount of a transition metal or a mixture of two or more transition metals. Suitable transition metals can include, for example, the elements from Groups 3 (scandium group), 4 (titanium group), 5 (vanadium group), 6 (chromium group), 7 (manganese group), 8-10 (iron, cobalt, nickel groups), and 11 (copper group) of the Periodic Table of the Elements, as well as combinations thereof. More typically, the transition metal is an early transition metal selected from Groups 3, 4, 5, 6, or 7 of the Periodic Table of Elements, such as, for example, hafnium, yttrium, molybdenum, tungsten, rhenium, chromium, titanium, zirconium, vanadium, tantalum, niobium, or a combination

In one embodiment of the present disclosure, the silver-based epoxidation catalyst includes silver, cesium, and rhenium. In another embodiment of the present disclosure, the silver-based epoxidation catalyst includes silver, cesium, rhenium and one or more species selected from Li, K, W, Zn, Mo, Mn, and S.

The silver-based epoxidation catalyst can also include a promoting amount of a rare earth metal or a mixture of two or more rare earth metals. The rare earth metals include any of the elements having an atomic number of 57-71, yttrium (Y) and scandium (Sc). Some examples of these elements include lanthanum (La), cerium (Ce), and samarium (Sm).

The transition metal or rare earth metal promoters are typically present in an amount of from about 0.1 micromoles per gram to about 10 micromoles per gram, more typically from about 0.2 micromoles per gram to about 5 micromoles per gram, and even more typically from about 0.5 micromoles per gram to about 4 micromoles per gram of total catalyst, expressed in terms of the metal. All of the aforementioned promoters, aside from the alkali metals, can be in any suitable form, including, for example, as zerovalent metals or higher valent metal ions.

The silver-based epoxidation catalyst can also include an amount of rhenium (Re), which is known as a particularly efficacious promoter for ethylene epoxidation high selectivity catalysts. The rhenium component in the catalyst can be in any suitable form, but is more typically one or more rhenium-containing compounds (e.g., a rhenium oxide) or complexes. The rhenium can be present in an amount of, for example, about 0.001 wt. % to about 1 wt. %. More typically, the rhenium is present in amounts of, for example, about 0.005 wt. % to about 0.5 wt. %, and even more typically, from about 0.01 wt. % to about 0.05 wt. % based on the weight of the total catalyst including the support, expressed as rhenium metal. All of these promoters, aside from the alkali metals, can be in any suitable form, including, for example, as zerovalent metals or higher valent metal ions.

After impregnation with silver and any promoters, the impregnated catalyst carrier of the present disclosure is removed from the solution and calcined for a time sufficient to reduce the silver component to metallic silver and to remove volatile decomposition products from the silver-containing support. The calcination is typically accomplished by heating the impregnated catalyst carrier, preferably at a gradual rate, to a temperature in a range of about 200° C. to about 600° C., more typically from about 200° C. to about 500° C., more typically from about 250° C. to about 500° C., and more typically from about 200° C. or 300° C. to about 450° C., at a reaction pressure in a range from about 0.5 to about 35 bar. In general, the higher the temperature, the shorter the required calcination period. A wide range of heating periods have been described in the art for the thermal treatment of impregnated supports. See, for example, U.S. Pat. No. 3,563,914, which indicates heating for less than 300 seconds, and U.S. Pat. No. 3,702,259, which discloses heating from 2 to 8 hours at a temperature of from 100° C. to 375° C. to reduce the silver salt in the catalyst. A continuous or step-wise heating program can be used for this purpose. During calcination, the impregnated catalyst carrier is typically exposed to a gas atmosphere comprising an inert gas, such as nitrogen. The inert gas can also include a reducing agent.

In another aspect, the present disclosure is directed to a method for the vapor phase production of ethylene oxide by conversion of ethylene to ethylene oxide in the presence of oxygen by use of the silver-based epoxidation catalyst described above. Generally, the ethylene oxide production process is conducted by continuously contacting an oxygen-containing gas with ethylene in the presence of the catalyst at a temperature in the range from about 180° C. to about 330° C., more typically from about 200° C. to about 325° C., and more typically from about 225° C. to about 270° C., at a pressure which can vary from about atmospheric pressure to about 30 atmospheres depending on the mass velocity and productivity desired. Pressures in the range of from about atmospheric to about 500 psi are generally employed. Higher pressures can, however, be employed within the scope of the present disclosure. Residence times in large-scale reactors are generally on the order of about 0.1 to about 5 seconds. A typical process for the oxidation of ethylene to ethylene oxide comprises the vapor phase oxidation of ethylene with molecular oxygen in the presence of the inventive catalyst in a fixed bed, tubular reactor. Conventional commercial fixed bed ethylene oxide reactors are typically in the form of a plurality of parallel elongated tubes (in a suitable shell). In one embodiment, the tubes are approximately 0.7 to 2.7 inches O.D. and 0.5 to 2.5 inches I.D. and 15-45 feet long filled with catalyst.

In some embodiments, the silver-based epoxidation catalyst described above exhibits a high level of selectivity in the oxidation of ethylene with molecular oxygen to ethylene oxide. For example, a selectivity value of at least about 83 mol % up to about 93 mol % can be achieved. In some embodiments, the selectivity is from about 87 mol % to about 93 mole %. The conditions for carrying out such an oxidation reaction in the presence of the silver-based epoxidation catalyst described above broadly comprise those described in the prior art. This applies, for example, to suitable temperatures, pressures, residence times, diluent materials (e.g., nitrogen, carbon dioxide, steam, argon, and methane), the presence or absence of moderating agents to control the catalytic action (e.g., 1, 2-dichloroethane, vinyl chloride or ethyl chloride), the desirability of employing recycle operations or applying successive conversion in different reactors to increase the yields of ethylene oxide, and any other special conditions which can be selected in processes for preparing ethylene oxide.

In the production of ethylene oxide, reactant feed mixtures typically contain from about 0.5 to about 45% ethylene and from about 3 to about 15% oxygen, with the balance comprising comparatively inert materials including such substances as nitrogen, carbon dioxide, methane, ethane, argon and the like. Only a portion of the ethylene is typically reacted per pass over the catalyst. After separation of the desired ethylene oxide product and removal of an appropriate purge stream and carbon dioxide to prevent uncontrolled build-up of inert products and/or by-products, unreacted materials are typically returned to the oxidation reactor.

Examples have been set forth below for the purpose of further illustrating the present disclosure. The scope of the present disclosure is not to be in any way limited by the examples set forth herein.

### Example 1

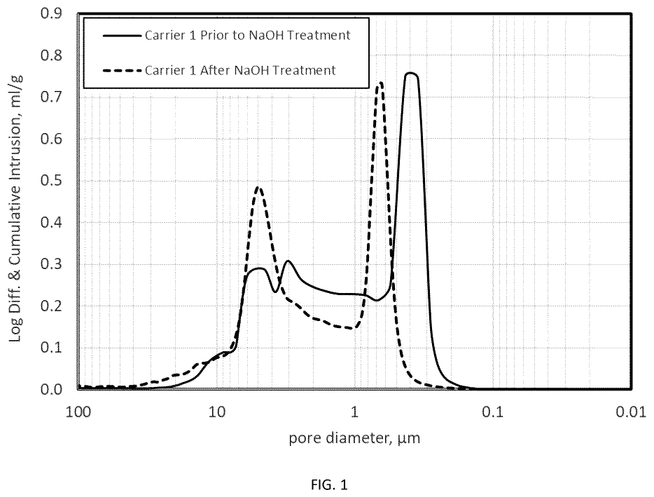

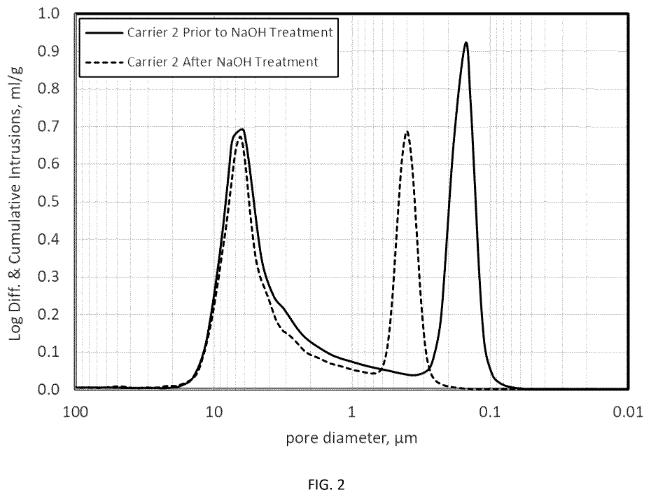

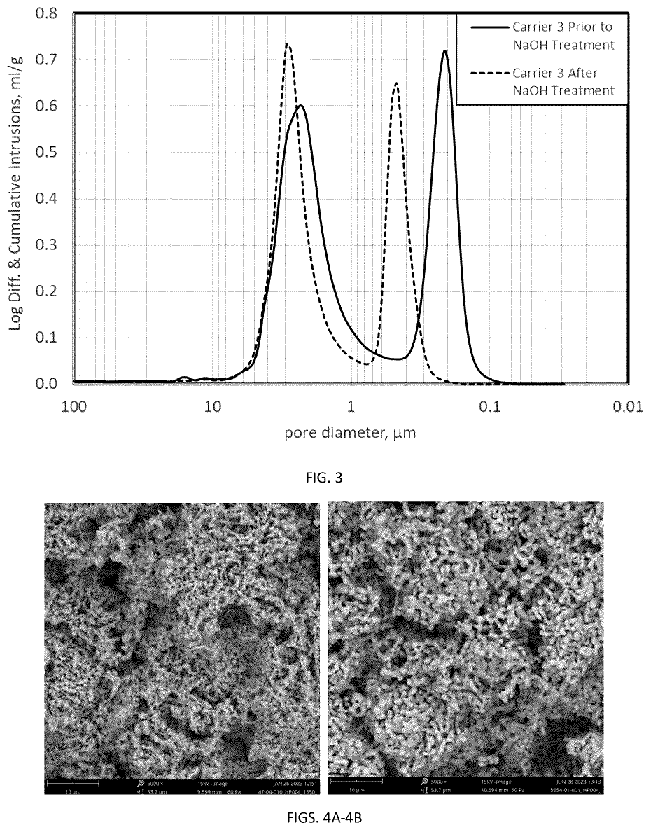

In this example, three preformed catalysts carriers, namely catalyst carriers 1, 2 and 3, were used to investigate the effects of NaOH treatment. The NaOH treatment included soaking each of catalysts carriers 1, 2 and 3 in 1M NaOH. The soaking was performed at a temperature of 80° C. for 3 hours. After the soaking process, each of the NaOH treated catalyst carriers were decanted, dried and then first calcined at a temperature of 700° C. Each of the NaOH treated catalyst carriers were then washed with deionized water, dried and second calcined at 1550° C. The catalyst carriers without NaOH treatment and with NaOH treatment were analyzed for pore size distribution and other properties as listed in Table 1. FIGS. 1-3 are graphs illustrating the pore size distribution of catalyst carriers 1, 2 and 3 prior to, and after, NaOH treatment.

The data in Table 1 shows that for each of the NaOH treated catalyst carriers there was a decrease in the surface area, water absorption, and pore volume as well as a reduction in small pores of less than 0.3 microns as compared to the equivalent untreated catalyst carrier. Also, the data in Table 1 shows that for each of the NaOH treated catalyst carriers there was an increase in average flat plate crush strength as well as an upward/positive shift in the pores modes as comparted to the equivalent untreated catalysts carrier. The upward/positive shift in the pore modes can be seen in FIGS. 1-3 of this disclosure. The data in Table 1 illustrates that NaOH treatment in accordance with the present disclosure can lead to a reduction of the small sized pores of less than 0.3 microns in a preformed catalyst carrier that includes such small sized pores.

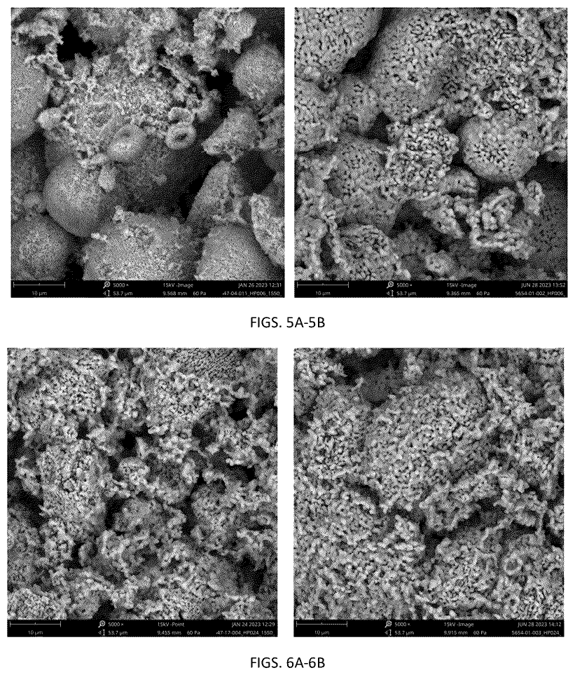

The effect of the NaOH treatment on the morphology of each of the catalyst carriers 1, 2 and 3 is show in the SEMs shown in FIGS. 4A-4B, FIGS. 5A-5B, and FIGS. 6A-6B. Notably, the SEMs shown in FIGS. 4A, 5A and 6A show the morphology of catalyst carriers 1, 2 and 3, respectively, prior to NaOH treatment, while the SEMs shown in FIGS. 4B, 5BA and 6B show the morphology of catalyst carriers 1, 2 and 3, respectively, after NaOH treatment.

Table 2 includes an XRF analysis of catalyst carrier 1 without NaOH treatment and with NaOH treatment. The XRF analysis shows that the impurities for catalyst carrier 1 without NaOH treatment and with NaOH treatment were similar, no significant increase in Na₂O was observed between the NaOH treated catalyst carrier and the untreated catalyst carrier.

TABLE 1
Examples With NaOH treatment

| | | | | | | | | PV % | |
|---|---|---|---|---|---|---|---|---|---|
| | | | | | | | PV less | less | |
| | | | BET | | Avg. | | than | than | |
| | NaOH | Calcining | Surface | Water | Crush | | 0.3 | 0.3 | Pore |
| Catalyst | Treatment | Temperature | area | Absorption | Strength | PV | microns | microns | modes |
| Carrier | (1M) | (° C.) | (m²/gm) | (%) | (N) | (mL/g) | (mL/g) | (%) | microns |
| 1 | No | 1450 | 1.91 | 52 | 98 | 0.482 | 0.015 | 3 | 0.4, 5 |
| 1 | Yes | 1550 | 0.87 | 38 | 105 | 0.385 | 0.001 | 0.3 | 0.64, 5 |
| 2 | No | 1500 | 4.16 | 55 | 55 | 0.539 | 0.199 | 37 | 0.15, 6 |
| 2 | Yes | 1550 | 1.19 | 40 | 91 | 0.403 | 0.006 | 2 | 0.4, 6 |
| 3 | No | 1450 | 2.94 | 47 | 69 | 0.456 | 0.159 | 35 | 0.21, 2.3 |
| 3 | Yes | 1550 | 1.14 | 36 | 98 | 0.357 | 0.004 | 1.2 | 0.47, 2.9 |

TABLE 2
XRF Analysis for catalyst carrier 1 prior
to NaOH treatment and after NaOH treatment

| | Na₂O | MgO | Al₂O₃ | SiO₂ | K₂O | CaO | Fe₂O₃ |
|---|---|---|---|---|---|---|---|
| Catalyst Carrier | (%) | (%) | (%) | (%) | (%) | (%) | (%) |
| Catalyst Carrier | 0.023 | 0.028 | 99.44 | 0.318 | 0.007 | 0.038 | 0.074 |
| 1 prior to NaOH | | | | | | | |
| treatment | | | | | | | |
| Catalyst Carrier | 0.029 | 0.031 | 99.44 | 0.303 | 0.012 | 0.040 | 0.072 |
| 1 after NaOH | | | | | | | |
| treatment & | | | | | | | |
| wash | | | | | | | |

### Example 2

In this example, the effects of added NaOH to a catalyst carrier preparation/formation process was investigated. Notably, and in the example, catalyst carrier 4 without added NaOH and with increasing amounts of added NaOH (0.3 wt. %, 0.6 wt. % and 1.2 wt. %) were made utilizing an identical carrier preparation process and carrier composition except for the non-addition or addition of NaOH. Catalyst carrier 4 is an alpha-alumina carrier that was made by providing a carrier composition including at least an alumina source, forming the carrier composition into a shaped body, and then calcining the shaped body at a temperature of 1550° C. Catalyst carrier 4A was made utilizing the identical catalyst carrier preparation/formation process and carrier composition as catalyst carrier 4 except that 0.3 wt. % of NaOH was added prior to the forming step. Catalyst carrier 4B was made utilizing the identical catalyst carrier preparation/formation process and carrier composition as catalyst carrier 4 except that 0.6 wt. % of NaOH was added prior to the forming step. Catalyst carrier 4C was made utilizing the identical catalyst carrier preparation/formation process and carrier composition as catalyst carrier 4 except that 1.2 wt. % of NaOH was added prior to the forming step. The physical properties of each of catalyst carrier 4, catalysts carrier 4A, catalyst carrier 4B and catalyst carrier 4C as listed in Table 3 were then determined.

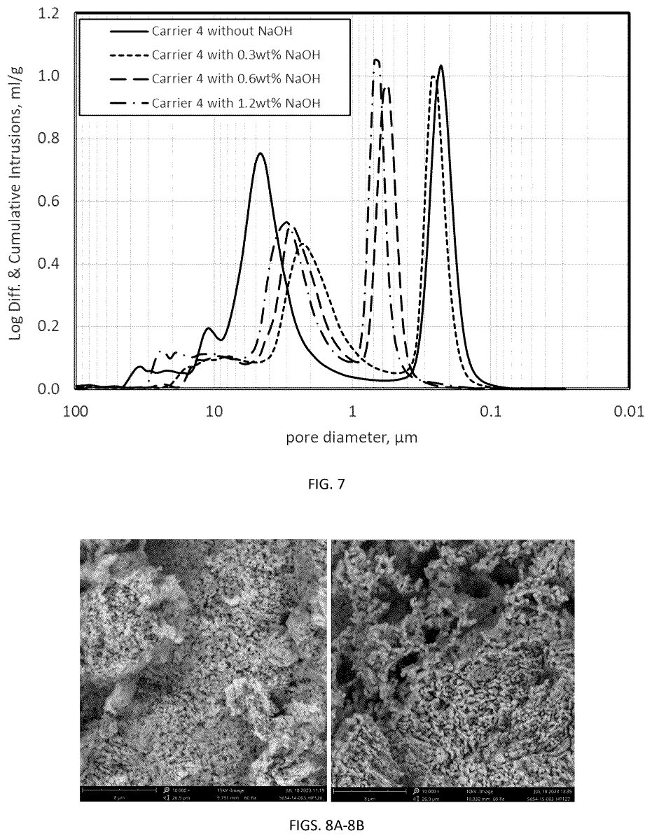

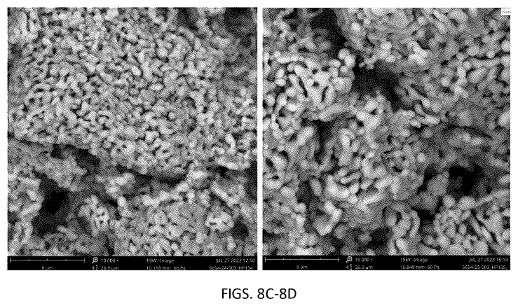

Catalyst carriers prepared with increased NaOH amounts as shown in Table 3 showed that the carrier properties are significantly affected by the NaOH levels, especially small pore size (0.3 microns) distributions. Increased NaOH also reduced surface area of the catalyst carrier. This example illustrates that the method of the present disclosure in which NaOH is added during the catalyst carrier preparation/formation process can be used to increase and control carrier small pore distributions. The small pore distribution shift can be clearly seen in FIG. 7 of the present disclosure. The SEMs shown in FIG. 8A (catalyst carrier 4 without NaOH), FIG. 8B (catalyst carrier 4A made with 0.3 wt. % NaOH), FIG. 8C (catalyst carrier 4B made with 0.6 wt. % NaOH) and FIG. 8D (catalyst carrier 4C made with 1.2 wt. % NaOH) show a visible change of morphology, particle size and porosity of the catalyst carrier depended on the NaOH levels.

TABLE 3
Effects of NaOH on Carrier Small Pore Distributions

| | | | | | | | | PV % | |
|---|---|---|---|---|---|---|---|---|---|
| | | | BET | | Avg. | | PV less | less | |
| | | Calcining | Surface | Water | Crush | Hg | than 0.3 | than 0.3 | Pore |
| Catalyst | NaOH | Temperature | area | Absorption | Strength | PV | microns | microns | modes |
| Carrier | Treatment | (° C.) | (m²/gm) | (%) | (N) | (mL/g) | (mL/g) | (%) | Microns |
| 4 | None | 1550 | 3.245 | 54 | 81 | 0.576 | 0.202 | 35 | 0.23, |
| | | | | | | | | | 4.6 |
| 4A | 0.3 wt. % | 1550 | 2.849 | 44 | 96 | 0.463 | 0.167 | 36.1 | 0.26, |
| | NaOH | | | | | | | | 2.3 |
| 4B | 0.6 wt. % | 1550 | 1.390 | 42 | 82 | 0.428 | 0.003 | 0.6 | 0.55, |
| | NaOH | | | | | | | | 2.7 |
| 4C | 1.2 wt. % | 1550 | 1.282 | 46 | 40 | 0.462 | 0.004 | 0.9 | 0.64, |
| | NaOH | | | | | | | | 2.9 |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A method of reducing small pore size distribution of a catalyst carrier comprising:
contacting a preformed catalyst carrier having a pore size distribution of less than 0.3 microns with a caustic solution to provide an admixture of the caustic solution and preformed catalyst carrier;
heating the admixture to a temperature of about 70° C. or greater to provide a caustic solution treated preformed catalyst carrier;
cooling the caustic solution treated preformed catalyst carrier to nominal room temperature;
drying the cooled caustic solution treated preformed catalyst carrier;
calcining the dried caustic solution treated preformed catalyst carrier at a temperature of about 1200° C. or greater; and
washing the calcined caustic solution treated preformed catalyst carrier to provide a catalyst carrier having a reduced pore volumes of pores having a pore size of less than 0.3 microns as compared to the preformed catalyst carrier.

2. The method of claim 1, wherein the caustic solution comprises a base having a pH value of about 13 or greater and water.

3. The method of claim 2, wherein the caustic solution has a molarity of from about 0.1 M to about 2 M.

4. The method of claim 3, wherein the caustic solution has a molarity of from about 0.5 M to about 1 M.

5. The method of claim 1, wherein the contacting includes adding the caustic solution to the preformed catalyst carrier in an amount from about 2 ml to about 20 ml per gram of preformed catalyst carrier employed.

6. The method of claim 5, wherein the contacting includes adding the caustic solution to the preformed catalyst carrier in an amount from about 5 ml to about 10 ml per gram of preformed catalyst carrier employed.

7. The method of claim 1, wherein the caustic solution is NaOH.

8. The method of claim 1, wherein the temperature of heating is from about 50° C. to about 90° C.

9. The method of claim 1, further comprising adding a catalytically effect amount of silver to the catalyst carrier.

10. The method of claim 1, further comprising adding a promoting amount of a transition metal or a mixture of two or more transition metals to the catalyst carrier.

11. A method of forming a catalyst carrier comprising:
adding a caustic solution to a carrier composition to provide an admixture of the carrier composition and caustic solution;
forming the admixture into a shaped body; and
calcining the shaped body at a temperature of about 1200° C. greater to convert the shaped body into a catalyst carrier.

12. The method of claim 11, wherein the caustic solution comprises a base having a pH value of about 13 or greater and water.

13. The method of claim 12, wherein the caustic solution has a molarity of from about 0.1 M to about 2 M.

14. The method of claim 13, wherein the caustic solution has a molarity of from about 0.5 M to about 1 M.

15. The method of claim 11, wherein the caustic solution is added in an amount from about 10 wt. % to about 50 wt. % based on a total amount of alumina source present in the carrier composition.

16. The method of claim 15, wherein the caustic solution is added in an amount from about 20 wt. % to about 30 wt. % based on a total amount of alumina source present in the carrier composition.

17. The method of claim 11, wherein the caustic solution is NaOH.

18. The method of claim 11, wherein the forming comprises extruding.

19. The method of claim 11, further comprising adding a catalytically effective amount of silver to the catalyst carrier.

20. The method of claim 19, further comprising adding a promoting amount of a transition metal or a mixture of two or more transition metals to the catalyst carrier.
